(19) United States
(12) Patent Application Publication
(10) Pub. No.: US 2024/0143392 A1
(43) Pub. Date: May 2, 2024

(54) TASK SCHEDULING METHOD, CHIP, AND ELECTRONIC DEVICE

(71) Applicant: INSPUR SUZHOU INTELLIGENT TECHNOLOGY CO., LTD., Suzhou, Jiangsu (CN)

(72) Inventors: Shuqing LI, Suzhou, Jiangsu (CN); Jiang WANG, Suzhou, Jiangsu (CN); Huajin SUN, Suzhou, Jiangsu (CN)

(21) Appl. No.: 18/280,215

(22) PCT Filed: Jan. 28, 2022
(86) PCT No.: PCT/CN2022/074613

§ 371 Date: Sep. 2, 2023

(30) Foreign Application Priority Data
Sep. 24, 2021 (CN) 202111118002.7

(51) Int. Cl. G06F 9/48

(52) U.S. Cl. CPC G06F 9/4881

(57) ABSTRACT

The preset application discloses a task scheduling method, including: in response to receiving an issued task, dividing, by a parser, the task into sub-tasks and generating a sub-task list, a task parameter corresponding to each sub-task is recorded in the sub-task list, the task parameter includes a start phase of a next sub-task; sending, by a scheduler, the task parameter of a sub-task to be processed in the sub-task list to a corresponding sub-engine; executing, by the corresponding sub-engine, a corresponding sub-task to be processed; sending a notification to the scheduler in response to an operating phase when the corresponding sub-engine executes the corresponding sub-task to be processed being the same as the start phase in the received task parameter; and in response to the notification being detected by the scheduler, returning to the step of sending the task parameter of a sub-task to be processed to a corresponding sub-engine.

### CROSS-REFERENCE TO RELATED APPLICATION

The present disclosure claims priority to Chinese patent application No. 202111118002.7, titled “TASK SCHEDULING METHOD, CHIP, AND ELECTRONIC DEVICE”, filed on Sep. 24, 2021 before China National Intellectual Property Administration, which is incorporated herein in its entirety by reference.

### TECHNICAL FIELD

The present disclosure relates to the field of acceleration architecture, and in particular to a task scheduling method, a chip and an electronic device.

### BACKGROUND

With a rapid development of emerging industries such as big data, artificial intelligence (AI), the fifth generation (5G), the massive data generated will grow exponentially, and the demand for computing power for data processing is increasing. Moore's Law and Dennard scaling Law jointly lead to a rapid development of the chip industry for 30 years. As the Moore's Law slows down and the Dennard scaling Law becomes invalid, improvement of computing power in a general central processing unit (CPU) has been unable to meet the demand of the current data center on computational power improvement. The heterogeneous computing based on the domain specific architecture (DSA) uses various accelerators to accelerate characteristic services, thereby improving system computing power and reducing costs. The most typical accelerator is the deep learning accelerator, no matter whether a graphics processing unit (GPU), a field-programmable gate array (FPGA) or various types of network processing units (NPU) are used, the computing power of the system can be improved by a plurality of times compared with the solution of merely using the CPU.

### SUMMARY

In view of the above, in order to overcome at least one aspect of the above-mentioned problem, an embodiment of the present disclosure proposes a task scheduling method, including:
in response to receiving an issued task, dividing, by a parser, the task into a plurality of sub-tasks and generating a sub-task list; a task parameter corresponding to each of the sub-tasks is recorded in the sub-task list, and the task parameter includes a start phase of a next sub-task;
sending, by a scheduler, the task parameter of a sub-task to be processed in the sub-task list to a corresponding sub-engine;
executing, by the corresponding sub-engine, a corresponding sub-task to be processed according to a received task parameter;
sending a notification to the scheduler in response to an operating phase when the corresponding sub-engine executes the corresponding sub-task to be processed being the same as the start phase in the received task parameter; and
in response to the notification being detected by the scheduler, returning to the step of sending, by a scheduler, the task parameter of a sub-task to be processed in the sub-task list to a corresponding sub-engine.

In some embodiments, the method further includes:
connecting the parser, the scheduler, and a plurality of sub-engines through an interconnection bus.

In some embodiments, the method further includes:
initializing a first counter, a second counter and a cache space of a preset size in each sub-engine respectively; and
setting an initial value of the first counter according to the size of the cache space of each sub-engine, and setting an initial value of the second counter as 0.

In some embodiments, the method further includes:
in response to a sub-engine sending a data request to another sub-engine, subtracting a size of the data to be requested in the data request from the first counter in the sub-engine sending the data request, and adding the size of the data to be requested in the data request to the second counter in the another sub-engine receiving the data request, the size of the data to be requested in the data request is not greater than the size of the corresponding cache space.

In some embodiments, the method further includes:
in response to outputting, by the another sub-engine receiving the data request, data to the sub-engine sending the data request according to the received data request, subtracting a size of the output data from the second counter in the another sub-engine receiving the data request; and
in response to receiving, by the sub-engine sending the data request, the data output by the another sub-engine receiving the data request, processing the output data and adding the first counter in the sub-engine sending the data request with a size of the data processed.

In some embodiments, the method further includes:
in response to a size of the first counter in the sub-engine sending the data request reaching a preset value, continuing to send data requests to other sub-engines.

In some embodiments, the sending a notification to the scheduler in response to an operating phase when the corresponding sub-engine executes the corresponding sub-task to be processed being the same as the start phase in the received task parameter further includes:
saving, by the corresponding sub-engine, the start phase in the task parameter in a first preset register;
outputting the current operating phase to a comparator in response to the corresponding sub-engine executing the corresponding sub-task to be processed;
comparing, by the comparator, the current operating phase with the start phase in the preset register; and
in response to the current operating phase being the same as the start phase in the preset register, issuing, by the comparator, the notification to the scheduler.

In some embodiments, the issuing, by the comparator, the notification to the scheduler further includes:
writing, by the comparator, a preset content into a second preset register; and
in response to the scheduler detecting a writing-in action, acquiring the content in the second preset register and determining, based on the content in the second preset register, whether to return to the step of sending, by a scheduler, the task parameter of a sub-task to be processed in the sub-task list to a corresponding sub-engine, and then sending the task parameter of a next sub-task to be processed to the corresponding sub-engine.

Based on the same creative concept, according to another aspect of the present disclosure, an embodiment of the present disclosure further provides a chip including a digital logic circuit that, when being operated, implements the steps of any one of the task scheduling methods described above.

Based on the same creative concept, according to another aspect of the present disclosure, an embodiment of the present disclosure further provides an electronic device, including the chip described above.

### BRIEF DESCRIPTION OF THE DRAWINGS

In order to explain the technical solutions of embodiment of the present disclosure or the related art more clearly, accompanying drawings which are needed in the illustration of the embodiments or the related art will be briefly introduced below. Apparently, the drawings in the description below are merely some embodiments of the present disclosure, for those skilled in the art, other embodiments may be obtained based on the drawings without paying any creative effort.

FIG. 1 is a schematic diagram illustrating an interaction mode between a scheduler and sub-engines in the related art;

FIG. 2 is a schematic flowchart of a task scheduling method provided in an embodiment of the present disclosure;

FIG. 3 is a schematic structural diagram illustrating connections among a scheduler, a parser, and sub-engines provided in an embodiment of the present disclosure;

FIG. 4 is a schematic diagram illustrating phases of sub-engines provided in an embodiment of the present disclosure;

FIG. 5 is a schematic diagram illustrating task scheduling implemented by the scheduler provided in an embodiment of the present disclosure;

FIG. 6 is a schematic diagram of a counter provided in an embodiment of the present disclosure;

FIG. 7 is a structural schematic diagram illustrating a chip provided in an embodiment of the present disclosure; and

FIG. 8 is a structural schematic diagram illustrating an electronic device provided in an embodiment of the present disclosure.

### DETAILED DESCRIPTION

In order that the objects, technical solutions and advantages of the present disclosure may be more clearly understood, embodiments of the present disclosure will be described in further detail below in combination with the detailed embodiments with reference to accompanying drawings.

It should be noted that all the expressions related to “first” and “second” in the embodiments of the present disclosure are used for distinguishing two different entities or different parameters with the same name. It can be seen that “first” and “second” are merely for the convenience of expressions and should not be understood as limiting the embodiments of the present disclosure, and the subsequent embodiments will not be described regarding this one by one.

The hardware accelerator of the domain specific architecture is designed for a certain business domain, and the business domain often contains multiple user scenarios. In each of the scenarios, the hardware accelerator needs to implement different functions that generally have similar or common characteristics. Therefore, when a hardware accelerator is designed, the functions to be implemented are generally split, so that the business processes in various scenarios are changed into a combination of respective independent sub-processes as much as possible, and a dedicated hardware acceleration module, called as a sub-engine, is designed for each sub-process.

The sub-engines are generally multiplexed among different user scenarios, i.e., a certain sub-engine may be used in multiple user scenarios, and the difference is that the task parameter of the sub-engine, the position of the sub-engine in the business process, and other sub-engines constituting the process may be different.

For example, a redundant array of independent disks (RAID) accelerator in a storage server can implement various scenarios such as RAID0/1/5/6, and functional modules such as a direct memory access (DMA) module, a storage page allocation/recovery module, a disk read/write module, an exclusive OR calculation module and a finite field calculation module can be obtained by splitting these scenarios into sub-flows. For RAID0/1, sub-engines 1 to 3 are required to be used, and these two scenarios have different task parameters of the sub-engines. For RAID5, sub-engines 1 to 4 are required to be used, and for RAID6, sub-engines 1 to 5 are required to be used.

The hardware accelerator, when being operated, implements the functions of different user scenarios by combining different sub-engines, and the order of the sub-engines in data flow is also different for each of the above-mentioned read/write sub-scenarios.

For example, for a read operation for RAID0, the hardware accelerator first schedules the storage page allocation module to allocate a block of data cache space; then the disk read/write module is called to read data from the disk and put the same into the cache space, and organization and sequencing of data for RAID0 is completed in the cache space; then the DMA module is called to move data from the cache space to a host-end memory; and finally, the storage page recovery module is called to recover the cache space. However, for the write operation for RAID0, after the storage page allocation module is called, the DMA module is called to transfer data from the host end to the cache space and complete the organization and sequencing of the data, then the disk read/write module is called to sequentially write the data in the cache space to the disk, and finally the cache space also needs to be recovered. Therefore, the sub-engines 1 to 3 are used both for the read and write scenarios of RAID0, but the calling sequence of the read scenario is 2-3-1-2, while the calling sequence of the write scenario is 2-1-3-2.

The scheduling of the sub-engines by the hardware accelerator is implemented using a module called as a parser and a module called as a scheduler. There are various implementations of the parser and the scheduler, which can be implemented in software or hardware. An implementation example is given below.

The parser parses the command from the host end according to the user scenario, decomposes the command into a plurality of sub-tasks, among them, each sub-task corresponds to one sub-engine; and organizes these sub-tasks into a list in order. The scheduler is used to dispatch the sub-tasks to the sub-engines, that is, reading a sub-task entry in the task list and then sending the same to a corresponding sub-engine according to a type of the sub-task entry.

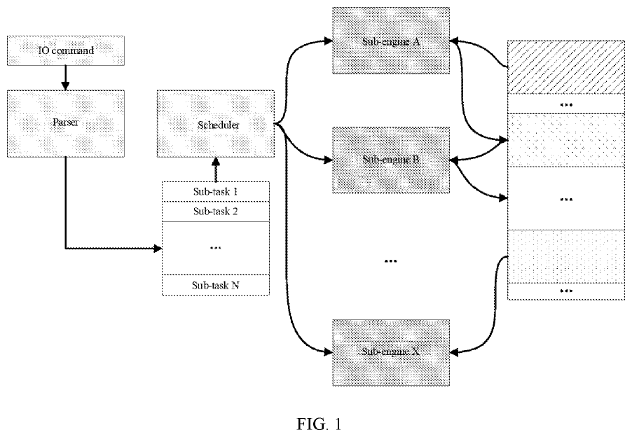

As shown in FIG. 1, the existing interaction between the scheduler and the sub-engines generally proceeds according to following steps:
1. the scheduler distributes the sub-tasks to the sub-engines;
2. after obtaining the task, the sub-engine reads data from a designated data cache area;
3, the sub-engine processes source data and writes processed data into the designated data cache area;
4, after all the data processing have been completed, the sub-engine notifies the scheduler;
5, the scheduler takes a next task from a task queue and dispatches the same to a next sub-engine; and
6, steps 2 to 5 are repeated until all steps have been performed.

The above-mentioned conventional method has various implementation forms, but generally has the following features: the sub-engine notifies the scheduler to start the next task after one sub-task is completed; the data cache area of each sub-task needs to be able to accommodate all the output data of the sub-task.

However, this method also has obvious disadvantages:
1. The IO delay is high. Since the sub-tasks are arranged end to end in time, the IO delay is equal to a sum of delays of all the sub-tasks; when a quantity of sub-tasks is large or a size of data block of the task is large, the IO delay tends to be unacceptable.
2. The requirement on the capacity of the data cache or bandwidth is relatively high. Since the data cache area needs to cache a complete data block output by one sub-engine, for a relatively large IO operation, for example, a whole stripe writing-in operation of RAID5, MB-level cache is often required; if an on-chip static random access memory (SRAM) is used, it would bring a high cost; and if an off-chip dynamic random access memory (DRAM) is used, since it needs to be commonly accessed by all the sub-engines, the bandwidth requirement is often difficult to meet.

Another type of traditional hardware accelerator is implemented with cascaded sub-engines, i.e., a data output port of sub-engine 1 is connected to a data input port of sub-engine 2, and so on. When sub-engine 1 outputs a first data, sub-engine 2 starts to work, and a first in first out (FIFO) interface or other streaming data interface is generally used between the engines. In this way, the hardware accelerator can achieve very low delay because that a pipelining operating manner is adopted between engines. Moreover, a data cache with a large capacity is not required, because a streaming interface is used between the engines. However, this traditional method has a big disadvantage of poor versatility, and thus it cannot be used for complex scenarios. Since the sub-engines need to directly exchange data in this method, the connection relationship of the sub-engines is relatively fixed. Even when a data selector is used, only a few options can be supported, and an order of data flow between engines cannot be changed. Therefore, only simple scenarios with relatively few processing steps and relatively fixed flows can generally be supported, and scenarios such as the RAID acceleration described above cannot be achieved.

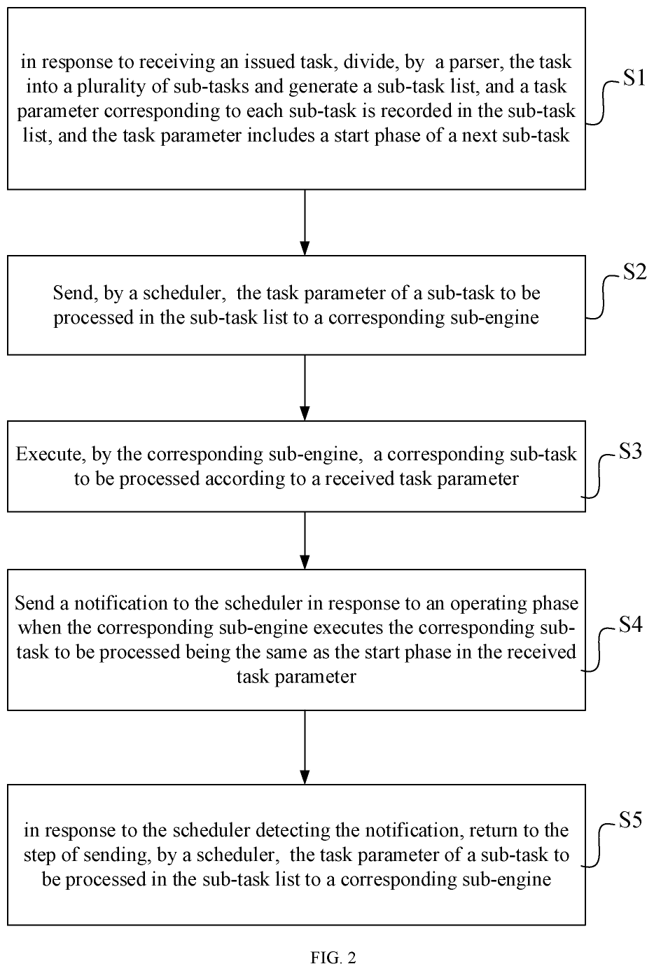

According to an aspect of the present disclosure, an embodiment of the present disclosure proposes a task scheduling method. FIG. 2 is a schematic flowchart of the task scheduling method provided in an embodiment of the present disclosure. As shown in FIG. 2, the method may include steps of:
S1, in response to receiving an issued task, dividing, by a parser, the task into a plurality of sub-tasks and generating a sub-task list, a task parameter corresponding to each sub-task being recorded in the sub-task list, the task parameter including a start phase of a next sub-task;
S2, sending, by a scheduler, the task parameter of a sub-task to be processed in the sub-task list to a corresponding sub-engine;
S3, executing, by the corresponding sub-engine, a corresponding sub-task to be processed according to the received task parameter;
S4, sending a notification to the scheduler in response to an operating phase when the corresponding sub-engine executes the corresponding sub-task to be processed being the same as the start phase in the received task parameter; and
S5, in response to the notification being detected by the scheduler, returning to the step of sending, by the scheduler, the task parameter of a sub-task to be processed in the sub-task list to a corresponding sub-engine.

The technical solution proposed in the present disclosure enables sub-tasks in a chronological order to partially or fully overlap in execution time. Therefore, compared with the traditional method, an overlapping time between all two engines in a chronological order can be saved. In general, for a task requiring N sub-engines, the solution proposed in the present disclosure can reduce the delay to 1/N thereof.

In some embodiments, the method further includes:
connecting the parser, the scheduler, and the plurality of sub-engines through an interconnection bus.

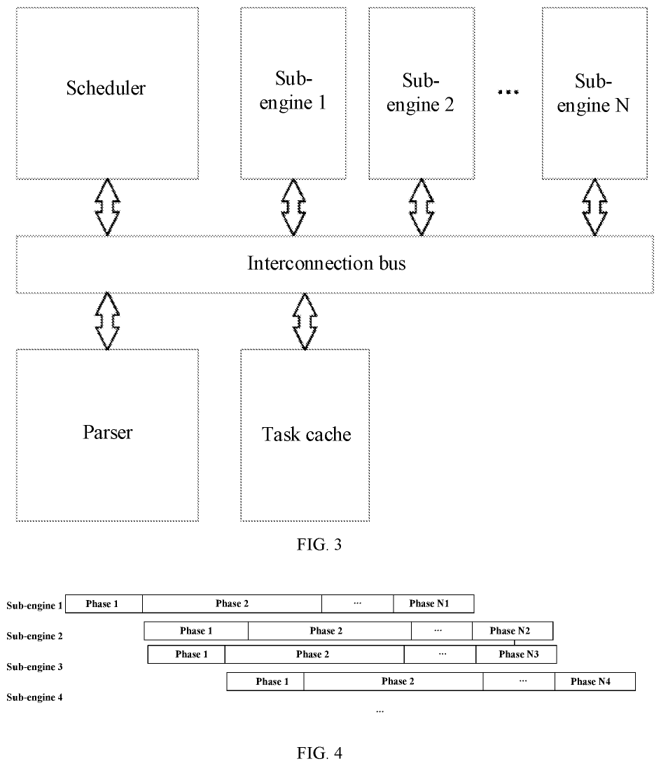

FIG. 3 shows a schematic structural diagram illustrating connections among the scheduler, the parser, and the sub-engines provided in an embodiment of the present disclosure. As shown in FIG. 3, instead of adopting dedicated interfaces among the sub-engines, the parser, the scheduler, the task buffer and a plurality of sub-engines are connected through an interconnection bus, thereby obtaining better universality. The interconnection bus may be based on a standard protocol such as advanced microcontroller bus architecture (AMBA) or a customized bus protocol. The interconnection bus may be implemented in various topologies such as Crossbar, Mesh or Ring. The interconnection bus is characterized in that any two components connected on the bus can access each other if necessary. In the present disclosure, the interconnection bus is used to carry both a control flow such as a sub-engine scheduling command and a data flow between sub-engines.

In some embodiments, in step S1, in response to receiving an issued task, the task is divided into a plurality of sub-tasks by the parser, and a sub-task list is generated, the task parameter corresponding to each sub-task being recorded in the sub-task list, and the task parameter including a start phase of the next sub-task. FIG. 4 is a schematic diagram illustrating phases of the sub-engines provided in an embodiment of the present disclosure, and as shown in FIG. 4, a task process of the sub-engine may be defined as a plurality of phases, and the quantity of phases and a time length of each phase vary according to an engine type and the task. For example, as shown in FIG. 4, one task process of sub-engine 1 may be phase 1, phase 2 . . . until phase N1. Each phase corresponds to a different stage of the task. For example, for an operation of moving data from a host to the local DMA, it can be divided into a plurality of stages, such as sending an address linked list reading command, waiting for the address linked list, receiving the address linked list, sending a data reading command, waiting for data, receiving data, etc.

For two sub-engines, the data flows of which are in a chronological order, the latter sub-engine may start executing at a start point or an end point of a certain phase of a previous sub-engine. The two sub-engines may also start at the same time, namely, the latter sub-engine starts to execute at the start point of phase 1 of the previous sub-engine. For example, as shown in FIG. 4, phase 1 of sub-engine 3 starts to execute at the start point of phase 1 of sub-engine 2; and the latter sub-engine may also execute at an end of a last phase of the previous sub-engine, as in conventional methods. Since the engines overlaps with each other in terms of time, the present disclosure reduces time delay compared to traditional methods.

The phase of a sub-engine and a task is pre-defined for different sub-engine types and tasks. When an IO command is parsed into the sub-task list, the parser adds the start phase of an engine in the task parameter of a previous sub-engine of the engine.

In some embodiments, in step S4, the sending a notification to the scheduler in response to an operating phase when the corresponding sub-engine executes the corresponding sub-task to be processed being the same as the start phase in the received task parameter further includes:
saving, by the corresponding sub-engine, the start phase in the task parameter in a first preset register;
outputting a current operating phase when the corresponding sub-engine executes the corresponding sub-task to be processed to a comparator;
comparing, by the comparator, the current operating phase with the start phase in the preset register; and
in response to the current operating phase being the same as the start phase in the preset register, issuing, by the comparator, the notification to the scheduler.

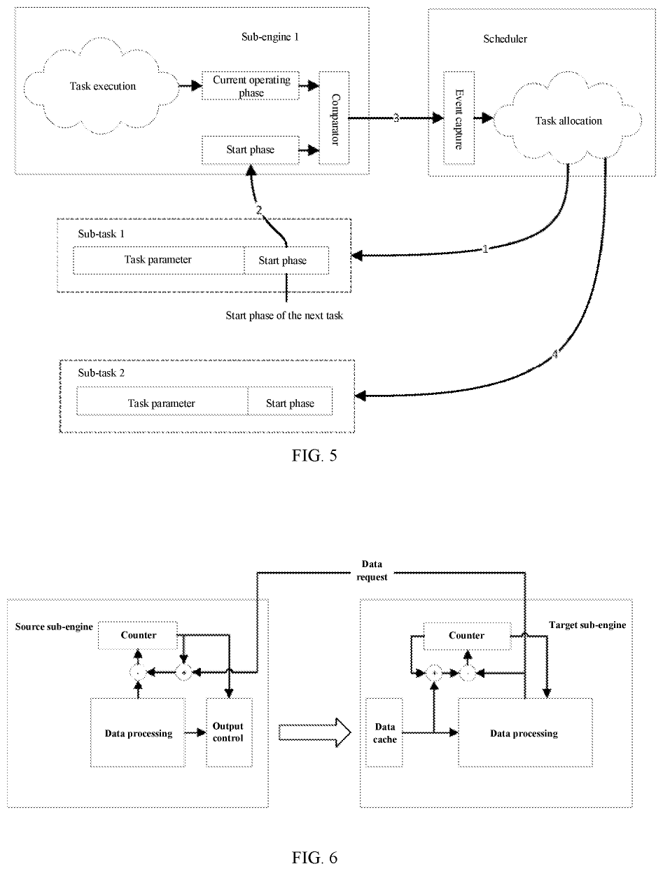

FIG. 5 is a schematic diagram illustrating task scheduling implemented by the scheduler provided in an embodiment of the present disclosure. As shown in FIG. 5, firstly, the scheduler obtains the task parameter (namely, indicated by arrow 1 in FIG. 5) of a sub-task (for example, sub-task 1), and then sends the same to sub-engine 1 (indicated by arrow 2 in FIG. 5). After receiving the task, the sub-engine may save the start phase of the next task in an internal register. A phase comparator circuit is implemented inside the sub-engine, and a task execution logic outputs the current operating phase. The phase is compared with the start phase stored in the register, and if the phase is equal to or exceeds the start phase, the comparator will issue an event notification to the scheduler (indicated by arrow 3 in FIG. 5), and the scheduler will obtain the task parameter (indicated by arrow 4 in FIG. 5) of the next sub-task (for example, sub-task 2) according to the event notification.

In some embodiments, in step S4, the issuing, by the comparator, the notification to the scheduler further includes:
writing, by the comparator, a preset content into a second preset register; and
in response to detecting a writing-in action by the scheduler, acquiring the content in the second preset register, and determining, based on the content, whether to return to the step of sending, by the scheduler, the task parameter of a sub-task to be processed in the sub-task list to a corresponding sub-engine, and then sending the task parameter of a next sub-task to be processed to the corresponding sub-engine.

The notification may be implemented by writing specific information to a register specified by the scheduler, the scheduler captures the event by detecting the writing-in action on the bus and discriminating the content of the writing-in. After the scheduler captures the event, the next task is dispatched to the corresponding sub-engine, and so on.

In some embodiments, the method further includes:
initializing a first counter, a second counter and a cache space of a preset size in each sub-engine respectively; and
setting an initial value of the first counter according to the size of the cache space of each sub-engine, and setting an initial value of the second counter as 0.

FIG. 6 is a schematic diagram of a counter provided in an embodiment of the present disclosure. As shown in FIG. 6, in the present disclosure, the data cache is implemented inside the sub-engine so as to reduce requirements for the capacity of the data cache and the bandwidth, and reduce the cost. Each sub-engine implements a small block of data cache, while the size of the cache is less than the size of a data block processed by one sub-task. The traditional method requires a data cache the size of which is equal to that of the data block of the sub-task, which is an essential difference between the present disclosure and the traditional method. In general, using the method of the present disclosure, the required cache will be much less than the data block of the sub-task in size, but the specific size of the cache can be determined according to specific design requirements.

In order to avoid overflow when a small data cache is used to process a large data block, the present disclosure uses two counters to realize a passive flow control method, in which a source sub-engine (the sub-engine receiving the data request) does not actively send data to a target sub-engine (the sub-engine sending the data request), and needs to wait for the data request sent by the target sub-engine. Different with the traditional method that performs handshake via signal lines of a dedicated data interface, the target sub-engine writes, through the interconnection bus, the data block size requested at this time to a specified register of the source sub-engine. After detecting the writing-in action of the bus on the specified register, the source sub-engine saves the request, and then sends no more than that size of data to the target sub-engine.

It should be noted that each sub-engine may serve as both the source sub-engine and the target sub-engine, so that two counters are provided in each sub-engine.

In some embodiments, the method further includes:
in response to a sub-engine sending a data request to another sub-engine, subtracting a data size to be requested in the data request from the first counter in the sub-engine sending the data request, and adding the data size to be requested in the data request to the second counter in another sub-engine receiving the data request, and the data size to be requested in the data request is not greater than the size of the corresponding cache space.

In some embodiments, the method further includes:
in response to outputting data, by another sub-engine receiving the data request, to the sub-engine sending the data request according to the received data request, subtracting a size of output data from the second counter in another sub-engine receiving the data request; and
in response to receiving, by the sub-engine sending the data request, data output by another sub-engine receiving the data request, processing the output data and adding the first counter in the sub-engine sending the data request with a size of a processed data.

In order to realize passive flow control, a counter needs to be implemented in the target sub-engine to store a remaining size of a current data cache, and the remaining size is not a remaining size of the data cache at a current moment, but a remaining size that needs to contain a part for which the request has been issued and the data has not yet reached the cache. The first counter operates according to the following rules:
1. an initial value of the counter is set as the size of the data cache;
2. the counter is subtracted by a requested value each time a data processing logic issues the data request;
3. the counter is added with one each time the data processing logic has processed one data;
4. the data request size of the data processing logic cannot exceed a current value of the counter.

At the same time, the source sub-engine also needs to implement a counter for saving an amount of data to be output, and the second counter operates according to the following rules:
1. an initial value is set as 0;
2. the counter is added with a size of a request each time a data request is received;
3. the counter is subtracted by one each time one data is output;
4. the output control logic may continue to output to the target sub-engine as long as the counter is not zero, otherwise a pause is required.

The core of the above-mentioned method or similar methods is that at any time, a total size of the data requests sent to the source sub-engine from the target sub-engine does not exceed the size of the data cache, and an amount of data sent from the source sub-engine to the target sub-engine does not exceed the requested amount.

In some embodiments, the method further includes:
in response to a size of the first counter in the sub-engine sending the data request reaching a preset value, continuing to send data requests to other sub-engines.

For guaranteed bus utilization, data requests may continue to be sent to other sub-engines after the first counter in the target sub-engine increases to the preset value.

Implementation of the present disclosure are described below by taking a two-disk RAID0 writing-in scenario for a RAID accelerator as an example.

Writing-in of a RAID0 requires:
a direct memory access (DMA) sub-engine for acquiring source data from a host via a peripheral component interconnect express (PCIe) bus;
a strip unit allocation sub-engine (hereinafter referred to as an allocation sub-engine) for corresponding continuous data to a strip unit;
two disk writing-in sub-engines, used for writing data of the corresponding stripe unit into a disk; and
a parser and a scheduler, and these two circuits are consistent with conventional usage.

The sub-engines are connected together by an advanced extensible interface (AXI) bus, and there is no dedicated wiring between the engines.

Assuming that the host sends a RAID0 write IO of 256 KB to the RAID accelerator, a disk page size is 4 KB, a data memory on the host end is discontinuous, and an address linked list is used for organization:

First, the parser parses the IO into four tasks as follows:
DMA: moving data of 256 KB from the host end into the accelerator;
Allocation: splitting data of 256 KB into two data blocks of 128 KB and outputting the same to two different target caches;
Disk writing-in 1: writing the first data block of 128 KB into disk 1; and
Disk writing-in 2: writing the second data block of 128 KB into disk 2.

Then, the parser performs a start phase configuration as follows:
The start phase of the allocation sub-engine is set as the address linked list, and is written into the task parameter the DMA sub-engine after being acquired;
The start phase of the disk writing-in 1 sub-engine is set as a start of the allocation sub-engine, and is written into the task parameter of the allocation sub-engine;
The start phase of the disk writing-in 2 sub-engine is set as a moment when the disk writing-in 1 sub-engine receives data of 2 KB, and is written into the task parameter of the disk writing-in 1 sub-engine;
After receiving the task, the DMA sub-engine saves the start phase of the allocation sub-engine in an internal register, then requests the address linked list from the host end via the PCIe bus; the host sends the address linked list to the DMA sub-engine via the PCIe bus after receiving the request; when the sub-engine receives a first address linked list data, it is the same as the start phase in the register, and then a notification is sent to the scheduler to request the allocation sub-engine to dispatch the next task; and the sub-engine stores the received address linked list in an internal cache.

After receiving the task, the allocation sub-engine saves the start phase of the disc writing-in 1 sub-engine in the internal register, and then starts to execute; at the beginning of execution, the comparator recognizes that the phase at this time is the same as that in the register, and then issues the notification to the scheduler to request for the next task to be dispatched to the disk writing in 1 sub-engine.

The scheduler dispatches the next task to the disk writing-in 1 sub-engine, and the disk writing-in 1 sub-engine saves the start phase of the disk writing-in 2 sub-engine in the internal register.

The allocation sub-engine initializes the first counter to 4 KB according to the cache size thereof (assuming that it is the size of one data page, and may also be less); then the data processing logic sends a data request of 4 KB to the DMA sub-engine, and reduces the first counter to zero.

The DMA sub-engine receives the data request of 4 KB, and adds the second counter to 4 KB; then the data processing logic sends a DMA data read request to the host one or more times according to a content of the address linked list; and the host sends data to the address of the allocation sub-engine via the PCIe bus.

The disk writing-in 1 sub-engine also initializes the first counter to 4 KB according to the cache size thereof (assumed to be one data page size); and then the allocation sub-engine sends a data request of 4 KB.

The allocation sub-engine receives data from the DMA, sends the same to the data processing module, and then outputs the same to the disk writing-in 1 sub-engine. With every 1 byte output to the disc writing-in 1 sub-engine, the second counter is subtracted with one, and the first counter is added with one; in order to ensure the utilization rate of the PCIe bus, whenever the first counter is greater than 1 KB, the allocation sub-engine requests data from the DMA sub-engine once.

The disk writing-in 1 sub-engine writes the received data into the disk as pages. When the processed data reaches 2 KB, the disk writing-in 1 sub-engine sends the notification to the scheduler to request for dispatching a task to the disk writing-in 2 sub-engine;
After receiving the task, the disk writing-in 2 sub-engines requests data of 4 KB from the allocation sub-engine.

The allocation sub-engine processes the data on the second page (the page needs to be written into the disk 2 at RAID0), and sends the data to disk writing-in 2 sub-engine; and disk writing-in 2 sub-engine writes the same into disk 2.

The foregoing steps are repeated until one IO operation is completed.

In the solution proposed in the present disclosure, sub-engines are connected through a common interconnection bus, and the sub-engines are scheduled via the task list and the scheduler, so as to ensure that the scheduler can schedule the sub-engines in an arbitrary order to realize the processing of a complex scenario. In addition, the task of sub-engines is split into a plurality of operating phases, and the purpose of reducing delay is achieved by overlapping the operating phases between the sub-engines. Unlike the traditional method in which the next sub-engine starts to operate after one sub-engine is completely finished, there may be a plurality of sub-engines serving the same IO task. The start phase of the next task is saved in the previous sub-engine and determined by the sub-engine, and then the scheduler is informed to schedule the next sub-engine. When a task is processed, the target sub-engine sends a request for a data block to the source sub-engine via the interconnection bus, which is different from the traditional method using a signal line connection method to realize flow control, and is also different from the traditional method using a bus interconnection without using flow control. The method enables the use of data caches less than the size of the data block, thereby reducing costs.

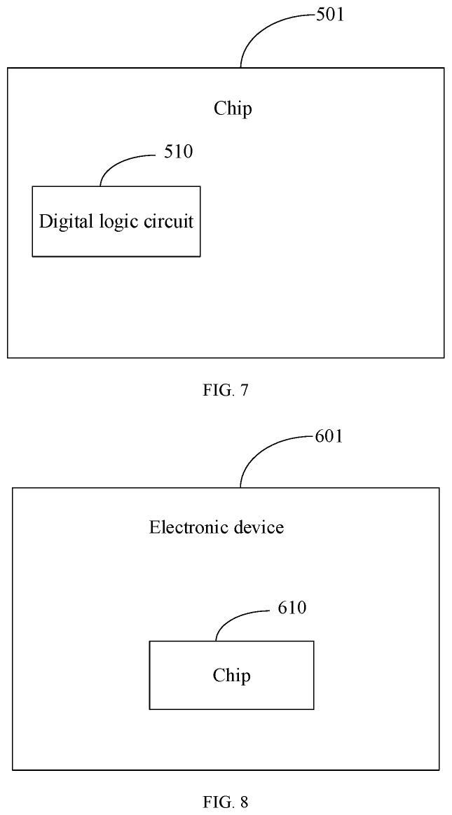

Based on the same creative concept, according to another aspect of the present disclosure, FIG. 7 is a structural schematic diagram illustrating a chip provided in an embodiment of the present disclosure. As shown in FIG. 7, the embodiment of the present disclosure also provides a chip 501, including:
a digital logic circuit 510 configured to implement the steps of the task scheduling method as described in any of the embodiments above.

Based on the same creative concept, according to another aspect of the present disclosure, FIG. 8 is a structural schematic diagram illustrating an electronic device provided in an embodiment of the present disclosure. As shown in FIG. 8, the embodiment of the present disclosure further provides an electronic device 601 including the chip 610 as described above.

Finally, it should be noted that, those skilled in the art can understand that all or part of the processes in the above method embodiments can be implemented by instructing related hardware through computer programs. The programs may be stored in a computer-readable storage medium. The programs, when being executed, may include the processes of the above method embodiments.

In addition, it should be appreciated that the computer-readable storage medium (e.g., memory) herein may be either a volatile memory or nonvolatile memory, or may include both the volatile memory and nonvolatile memory.

Those skilled in the art would also appreciate that various illustrative logical blocks, modules, circuits, and algorithm steps described in connection with the disclosure herein may be implemented as an electronic hardware, a computer software, or combinations of both. To clearly illustrate such interchangeability of hardware and software, various illustrative components, blocks, modules, circuits, and steps have been described generally in terms of their functionality. Whether such functionality is implemented as software or as hardware depends upon the particular application and design constraints imposed on the overall system. Those skilled in the art may implement the functions in various ways for each specific application, but such implementation decisions should not be interpreted as causing a departure from the scope disclosed in the embodiments of the present application.

The above are exemplary embodiments of in the present disclosure, but it should be noted that various changes and modifications can be made without departing from the scope of the embodiments of the present disclosure defined by the claims. The functions, steps and/or actions of the method claims in accordance with the embodiments described herein need not be performed in any particular order. In addition, although the elements disclosed in the embodiments may be described or required in an individual form, they may also be understood as plural unless explicitly limited to a singular number.

It should be understood that a singular form “a” and “an” as used herein is intended to include the plural forms as well, unless the context clearly supports an exception. It should also be understood that “and/or” as used herein is meant to include any and all possible combinations of one or more of the associated listed items.

The serial numbers of the embodiments disclosed above are only for description, and do not represent the advantages and disadvantages of the embodiments.

Those skilled in the art can understand that all or part of the steps for implementing the above-mentioned embodiments can be completed by hardware, or can be completed by instructing related hardware through a program, and the program can be stored in a computer-readable storage medium. The above-mentioned storage medium may be a read-only memory, a magnetic disk or an optical disk, and the like.

Those skilled in the art should understand that the discussion of any of the above embodiments is exemplary only, and is not intended to imply that the scope (including claims) of the embodiments of the present disclosure is limited to these examples. Under the idea of the embodiments of the present disclosure, the technical features in the above embodiments or different embodiments can also be combined, and there are many other changes in different aspects of the above embodiments of the present disclosure, which are not provided in details for the sake of brevity. Therefore, within the spirit and principle of the embodiments of the present disclosure, any omissions, modifications, equivalent replacements, improvements, etc., shall be included in the protection scope of the embodiments of the present disclosure.

1. A task scheduling method, comprising:
in response to receiving an issued task, dividing, by a parser, the task into a plurality of sub-tasks and generating a sub-task list, wherein a task parameter corresponding to each of the sub-tasks is recorded in the sub-task list, and the task parameter comprises a start phase of a next sub-task;
sending, by a scheduler, the task parameter of a sub-task to be processed in the sub-task list to a corresponding sub-engine;
executing, by the corresponding sub-engine, a corresponding sub-task to be processed according to a received task parameter;
sending a notification to the scheduler in response to an operating phase when the corresponding sub-engine executes the corresponding sub-task to be processed being the same as the start phase in the received task parameter; and
in response to the notification being detected by the scheduler, returning to the step of sending, by a scheduler, the task parameter of a sub-task to be processed in the sub-task list to a corresponding sub-engine.

2. The method according to claim 1, further comprising:
connecting the parser, the scheduler, and a plurality of sub-engines through an interconnection bus.

3. The method according to claim 1, further comprising:
initializing a first counter, a second counter and a cache space of a preset size in each sub-engine respectively; and
setting an initial value of the first counter according to the size of the cache space of each sub-engine, and setting an initial value of the second counter as 0.

4. The method according to claim 3, further comprising:
in response to a sub-engine sending a data request to another sub-engine, subtracting a size of the data to be requested in the data request from the first counter in the sub-engine sending the data request, and adding the size of the data to be requested in the data request to the second counter in the another sub-engine receiving the data request, wherein the size of the data to be requested in the data request is not greater than the size of the corresponding cache space.

5. The method according to claim 4, further comprising:
in response to outputting, by the another sub-engine receiving the data request, data to the sub-engine sending the data request according to the received data request, subtracting a size of the output data from the second counter in the another sub-engine receiving the data request; and
in response to receiving, by the sub-engine sending the data request, the data output by the another sub-engine receiving the data request, processing the output data and adding the first counter in the sub-engine sending the data request with a size of the data processed.

6. The method according to claim 5, further comprising:
in response to a size of the first counter in the sub-engine sending the data request reaching a preset value, continuing to send data requests to other sub-engines.

7. The method according to claim 1, wherein the sending a notification to the scheduler in response to an operating phase when the corresponding sub-engine executes the corresponding sub-task to be processed being the same as the start phase in the received task parameter further comprises:
saving, by the corresponding sub-engine, the start phase in the task parameter in a first preset register;
outputting the current operating phase to a comparator in response to the corresponding sub-engine executing the corresponding sub-task to be processed;
comparing, by the comparator, the current operating phase with the start phase in the first preset register; and
in response to the current operating phase being the same as the start phase in the first preset register, issuing, by the comparator, the notification to the scheduler.

8. The method according to claim 7, wherein the issuing, by the comparator, the notification to the scheduler further comprises:
writing, by the comparator, a preset content into a second preset register; and
in response to the scheduler detecting an action of the writing, acquiring the content in the second preset register and determining, based on the content in the second preset register, whether to return to the step of sending, by a scheduler, the task parameter of a sub-task to be processed in the sub-task list to a corresponding sub-engine, and then sending the task parameter of a next sub-task to be processed to the corresponding sub-engine.

9. A chip, comprising a digital logic circuit configured to execute operations of:
in response to receiving an issued task, dividing, by a parser, the task into a plurality of sub-tasks and generating a sub-task list, wherein a task parameter corresponding to each of the sub-tasks is recorded in the sub-task list, and the task parameter comprises a start phase of a next sub-task;
sending, by a scheduler, the task parameter of a sub-task to be processed in the sub-task list to a corresponding sub-engine;
executing, by the corresponding sub-engine, a corresponding sub-task to be processed according to a received task parameter;
sending a notification to the scheduler in response to an operating phase when the corresponding sub-engine executes the corresponding sub-task to be processed being the same as the start phase in the received task parameter; and
in response to the notification being detected by the scheduler, returning to the step of sending, by a scheduler, the task parameter of a sub-task to be processed in the sub-task list to a corresponding sub-engine.

10. An electronic device, comprising:
a memory for storing a computer program; and
a processor for executing the computer program to implement operations of:
in response to receiving an issued task, dividing, by a parser, the task into a plurality of sub-tasks and generating a sub-task list, wherein a task parameter corresponding to each of the sub-tasks is recorded in the sub-task list, and the task parameter comprises a start phase of a next sub-task;
sending, by a scheduler, the task parameter of a sub-task to be processed in the sub-task list to a corresponding sub-engine;
executing, by the corresponding sub-engine, a corresponding sub-task to be processed according to a received task parameter;
sending a notification to the scheduler in response to an operating phase when the corresponding sub-engine executes the corresponding sub-task to be processed being the same as the start phase in the received task parameter; and
in response to the notification being detected by the scheduler, returning to the step of sending, by a scheduler, the task parameter of a sub-task to be processed in the sub-task list to a corresponding sub-engine.

11. The method according to claim 2, wherein the interconnection bus is based on a standard protocol or a customized bus protocol, and the interconnection bus is implemented in a topology of Crossbar, Mesh or Ring.

12. The method according to claim 2, wherein the interconnection bus is used to carry both a control flow comprising a sub-engine scheduling command and a data flow between the sub-engines.

13. The method according to claim 1, wherein a task process of the sub-engine is defined as a plurality of phases, and a quantity of phases and a time length of each phase vary according to an engine type and the task.

14. The method according to claim 13, wherein each phase corresponds to a different stage of the task.

15. The electronic device according to claim 10, wherein the processor is further configured to implement operations of:
connecting the parser, the scheduler, and a plurality of sub-engines through an interconnection bus.

16. The electronic device according to claim 10, wherein the processor is further configured to implement operations of:
initializing a first counter, a second counter and a cache space of a preset size in each sub-engine respectively; and
setting an initial value of the first counter according to the size of the cache space of each sub-engine, and setting an initial value of the second counter as 0.

17. The electronic device according to claim 16, wherein the processor is further configured to implement operations of:
in response to a sub-engine sending a data request to another sub-engine, subtracting a size of the data to be requested in the data request from the first counter in the sub-engine sending the data request, and adding the size of the data to be requested in the data request to the second counter in the another sub-engine receiving the data request, wherein the size of the data to be requested in the data request is not greater than the size of the corresponding cache space.

18. The electronic device according to claim 17, wherein the processor is further configured to implement operations of:
in response to outputting, by the another sub-engine receiving the data request, data to the sub-engine sending the data request according to the received data request, subtracting a size of the output data from the second counter in the another sub-engine receiving the data request; and
in response to receiving, by the sub-engine sending the data request, the data output by the another sub-engine receiving the data request, processing the output data and adding the first counter in the sub-engine sending the data request with a size of the data processed.

19. The electronic device according to claim 18, wherein the processor is further configured to implement operations of:
in response to a size of the first counter in the sub-engine sending the data request reaching a preset value, continuing to send data requests to other sub-engines.

20. The electronic device according to claim 10, wherein the processor is further configured to implement operations of:
saving, by the corresponding sub-engine, the start phase in the task parameter in a first preset register;
outputting the current operating phase to a comparator in response to the corresponding sub-engine executing the corresponding sub-task to be processed;
comparing, by the comparator, the current operating phase with the start phase in the first preset register; and
in response to the current operating phase being the same as the start phase in the first preset register, issuing, by the comparator, the notification to the scheduler.
